(19) United States
(12) Patent Application Publication
(10) Pub. No.: US 2026/0255419 A1
(43) Pub. Date: Aug. 27, 2026

(54) ROAMING AND PRIVACY TECHNIQUES

(71) Applicant: Cisco Technology, Inc., San Jose, CA (US)

(72) Inventors: Domenico FICARA, Essertines-Sur-Yverdon (CH); Ugo M. CAMPIGLIO, Morges (CH); Jerome HENRY, Pittsboro, NC (US); Javier I. CONTRERAS ALBESA, Sant Cugat del Valles (ES); Federico LOVISON, Fontanelle (IT)

(21) Appl. No.: 19/352,292

(22) Filed: Oct. 7, 2025

Related U.S. Application Data
(60) Provisional application No. 63/768,746, filed on Mar. 7, 2025.
(60) Provisional application No. 63/761,637, filed on Feb. 21, 2025.

(51) Int. Cl. H04W 76/15; H04W 8/08; H04W 12/02

(52) U.S. Cl. CPC H04W 76/15; H04W 8/08; H04W 12/02

(57) ABSTRACT

The present disclosure provides techniques for managing association identifier (AID) assignment in enhanced data privacy (EDP) operation. An access point (AP) establishes a wireless communications link with a station, comprising receiving an association request frame from the wireless station, assigning the station to an EDP group, generating a first list of N AIDs for the station, each of the N AIDs to be used in a corresponding epoch of N epochs associated with the EDP group, and transmitting an association response frame to the station, where the response frame comprises information indicating the assigned EDP group and the first list of N AIDs for the wireless station. The AP maintains the wireless communications link with the wireless station based at least in part on the timing information for randomized MAC address rotation for the EDP group, comprising using each AID in the list of N AIDs during corresponding epochs.

### CROSS-REFERENCE TO RELATED APPLICATIONS

This application claims benefit of co-pending United States provisional patent application Serial No. 63/761,637 filed Feb. 21, 2025, and co-pending United States provisional patent application Serial No. 63/768,746 filed Mar. 7, 2025. The aforementioned related patent applications are herein incorporated by reference in their entirety.

### TECHNICAL FIELD

Embodiments presented in this disclosure generally relate to wireless communication. More specifically, embodiments disclosed herein relate to association identifier (AID) assignment for seamless roaming in enhanced data privacy (EDP) networks.

### BACKGROUND

IEEE 802.11 is moving toward developing mechanisms to enhance user privacy in wireless local area networks (WLANs). One recent focus is to minimize the exposure of persistent identifiers that could enable passive tracking of client devices. To achieve this goal, identifiers transmitted during data exchange, management procedures, or other protocol operations are proposed to be anonymized or periodically rotated. These enhancements are intended to make it more difficult for a third party, such as an eavesdropper, to correlate transmissions over time and infer the identity or location of users.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example of client roaming in enhanced data privacy (EDP) networks, according to some embodiments of the present disclosure.

FIG. 2 depicts an example of client roaming where an AID list is included in a (re)association response, according to some embodiments of the present disclosure.

FIG. 3 depicts an example of client roaming where an AID list is conditionally provisioned based on proximity to an epoch boundary, according to some embodiments of the present disclosure.

FIG. 4 depicts an example of client roaming where an AP responds with a retry indication, according to some embodiments of the present disclosure.

FIG. 5 depicts an example of client roaming where an EDP transitory period is extended to allow data transmission prior to AID list delivery, according to some embodiments of the present disclosure.

FIG. 6 depicts an example of client roaming where an EDP transitory period is extended to allow full association choreography prior to AID list delivery, according to some embodiments of the present disclosure.

FIG. 7 depicts an example of client roaming where a STA extends a current EDP epoch until valid AIDs are received, according to some embodiments of the present disclosure.

FIG. 8 depicts an example method for AID list provisioning in a (re)association response, according to some embodiments of the present disclosure.

FIG. 9 depicts an example method for conditionally AID list provisioning based on epoch proximity, according to some embodiments of the present disclosure.

FIG. 10 depicts an example method for AID provisioning with a retry-based association, according to some embodiments of the present disclosure.

FIG. 11 depicts an example method for AID provisioning with EDP transitory period extension, according to some embodiments of the present disclosure.

FIG. 12 depicts an example method for AID provisioning in response to a STA-initiated epoch extension, according to some embodiments of the present disclosure.

FIG. 13 depicts an example method for STA-initiated epoch extension, according to some embodiments of the present disclosure.

FIG. 14 is a block diagram depicting an example method for AID assignment during roaming, according to some embodiments of the present disclosure.

FIG. 15 depicts an example network device configured to perform various embodiments of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including establishing a wireless communications link between an access point (AP) and a wireless station, where establishing the wireless communications link comprises receiving an association request frame from the wireless station, assigning the wireless station to an Enhanced Data Privacy (EDP) group, the EDP group associated with timing information for rotating wireless frame anonymization parameters at epoch transitions, generating, by the AP, a first list of N association identifiers (AIDs) for the wireless station, each of the N AIDs to be used in a corresponding epoch of N epochs associated with the EDP group, and transmitting an association response frame to the wireless station, where the response frame comprises information indicating the assigned EDP group and the first list of N AIDs for the wireless station, and maintaining, by the AP, the wireless communications link with the wireless station based at least in part on the timing information for randomized media access control (MAC) address rotation for the EDP group, comprising using each AID in the list of N AIDs during corresponding epochs.

Other embodiments in this disclosure provide a non-transitory computer readable medium comprising instructions that when executed configure one or more processors of a wireless access point (AP) to perform operations in accordance with one or more of the above methods, as well as a wireless AP comprising at least one memory element for storing data, and at least one processor for executing instructions associated with the data, wherein executing the instructions causes the AP to perform operations in accordance with one or more of the above methods.

### Example Embodiments

IEEE 802.11bi is moving toward enhancing user privacy in wireless local area networks (WLANs). One focus is to minimize the exposure of persistent identifiers that could be exploited to track a station (STA) (also referred to as a client device) over time. To improve privacy protection, IEEE 802.11bi proposes the anonymization or periodic rotation of identifiers (IDs) exchanged during management procedures and data transmissions.

The association identifier (AID) is one such identifier. In current systems, the AID is assigned by the access point (AP) during the association process and remains static for the duration of the session. To support enhanced privacy, IEEE 802.11bi shifts away from the fixed AIDs and instead introduces periodic AID refresh. Under this framework, the AID may be delivered in the form of a list, such as via an action frame, with each AID to be used sequentially across successive enhanced data privacy (EDP) epochs.

However, this approach introduces challenges, particularly in scenarios where the STA attempts to associate or roam very close to the end of an EDP epoch. In such cases, the STA may quickly exhaust its current AID and be left without a valid AID until the AP delivers a new list. The timing and reliability of the AID list delivery via action frames is not guaranteed, and in the interim, the STA may lack a valid AID required for transmitting data frames under the EDP’s privacy limitations.

The unavailability of valid AIDs can be particularly problematic for latency-sensitive applications such as voice or video calls. A roaming STA that temporarily lacks a valid AID may experience interruptions in data communication, which can be perceptible to the end user. Moreover, in dense deployments with frequent roaming or when using very short epoch intervals (as preferred by some vendors for increased privacy), these timing mismatches become more frequent and impactful. The STA’s inability to transmit or receive properly authenticated frames during these gaps may also degrade overall quality of service (QoS) and introduce delays in reestablishing encrypted sessions or multicast group memberships.

The present disclosure provides methods, systems, and apparatuses for accelerating and managing AID provisioning during association or roaming procedures near epoch boundaries. The present disclosure introduces techniques that minimize (or at least reduce) the duration during which a STA operates without a valid AID, such as during fast roaming events or when deployed in networks configured with short epoch intervals.

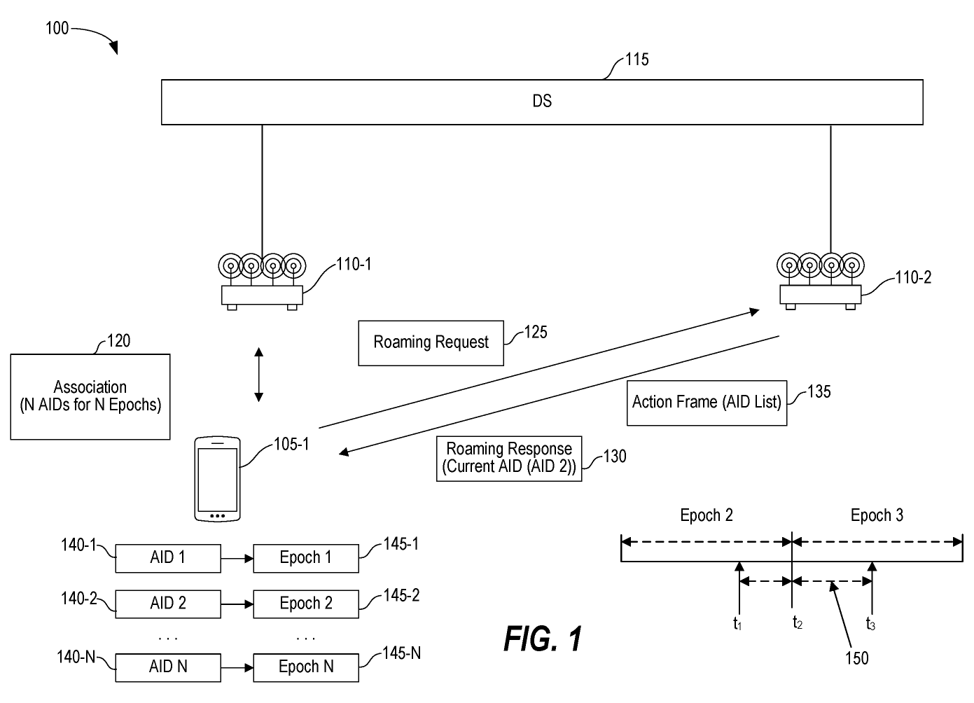

FIG. 1 depicts an example 100 of client roaming in enhanced data privacy (EDP) networks, according to some embodiments of the present disclosure.

In EDP-based IEEE 802.11bi networks, identifiers such as the association identifier (AID) are subject to anonymization or periodic rotation to enhance user privacy. The AID is configured as a time-bound identifier that changes across successive EDP epochs. A list of future AIDs may be pre-assigned and delivered to a station (or client device) by an access point (AP), with each AID intended to be consumed in order over time.

As depicted, a station (STA) is initially associated with a first AP 110-1, which is connected to a distribution system (DS) 115. A second AP 110-2 is also connected to the same DS 115 and supports roaming for STA 105-1. As used herein, the STA 105-1 may refer to a single-link device or a multi-link device (or STA MLD), and the AP 110 may refer to a single-link AP or a multi-link AP (or AP MLD).

As illustrated, during initial association 120 with AP 110-1, a list of N AIDs is provisioned for the STA, corresponding to N successive EDP epochs. Each AID 140 is assigned to a specific epoch 145 in sequential order. As depicted, AID 1 (140-1) is valid during epoch 1 (145-1), AID 2 (140-2) is valid during epoch 2 (145-2), and so on, up to AID N (140-N) for epoch N (145-N). At some point, STA 105-1 roams from AP 110-1 to AP 110-2. The roaming event begins when the STA transmits a roaming request 125 (e.g., a (re)association request or link reconfiguration request frame) to AP 110-2. Upon receiving the request, AP 110-2 evaluates the STA’s request and, if accepted, responds with a roaming response 130 (e.g., a (re)association response) that includes the current AID assigned for the active epoch. For example, if roaming occurs during epoch 2 (145-2), the response 130 includes AID 2 (140-2). The current AID allows the STA to continue operating with a valid identifier immediately upon handover.

AP 110-2 does not reuse the AID assignments created by AP 110-1, even if both APs belong to the same EDP group. AP 110-2 generates a new set of AIDs within its own context. Upon receiving the roaming request 125, AP 110-2 includes the newly generated AID for the current epoch in the roaming response 130. The AP 110-2 then provides the STA 105-1 with a complete list of AIDs for subsequent epochs through a follow-up action frame 135. Because both APs may share the same privacy context, the STA 110-1 can still perform seamless roaming, but it will use the identifiers generated by the target AP for ongoing communication.

In some embodiments, the target AP 110-2 may advertise support for randomized media access control (MAC) address rotation management protocols for EDP in beacon or probe response frames. Such indications may help a roaming STA determine compatibility and privacy capabilities prior to (re)associations. During the roaming request 125, the STA 105-1 may include its rotation management preferences, such as a desired rotation interval or pace for its randomized MAC address. Upon receiving the preferences, AP 110-2 may use these preferences, along with other privacy context information, to determine or adjust the generation and assignment of the AID list.

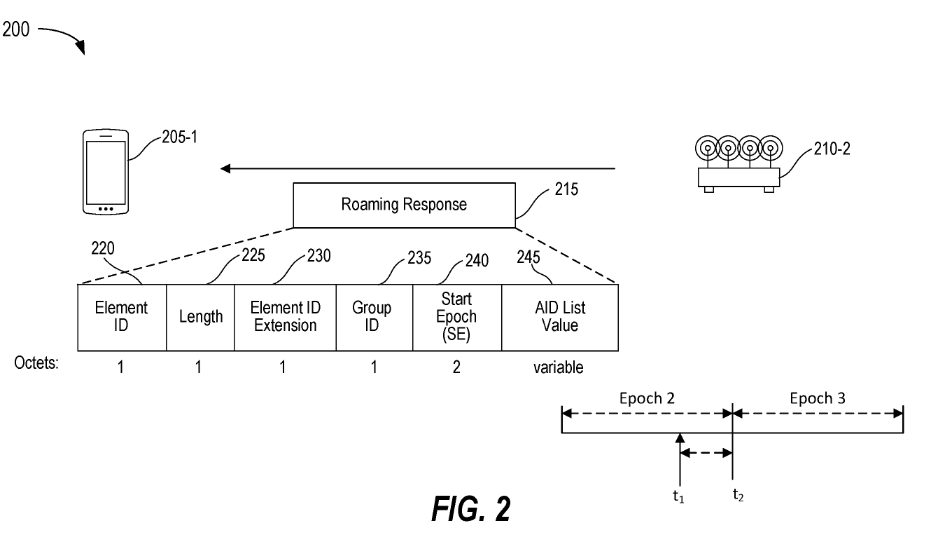

As illustrated in the timing sequence, the roaming request 125 is sent at time t₁ during epoch 2, and the action frame including the full AID list is sent at time t₃, during epoch 3. Epoch 2 ends and epoch 3 starts at time t₂, which falls between the two transmissions. As a result, during the time gap 150 between t₂ and t_{3,} the STA 105-1 does not yet possess a valid AID for epoch 3 and is unable to transmit or receive new data frames during that period. The transient unavailability of a valid AID may impact application-layer performance, particularly for latency-sensitive traffic (e.g., voice or video traffic). The present disclosure provides various mechanisms that manage and/or accelerate AID assignment in order to avoid (or at least reduce) the duration during which a STA lacks a valid AID. These mechanisms improve reliability during roaming events, particularly when roaming occurs near epoch boundaries or in networks configured with short epoch intervals. More details about these mechanisms are discussed below with reference to FIGS. 2-7.

The number of AIDs (N) provisioned to the STA 105-1 during initial association or after roaming is provided as an example and may vary depending on implementation and network configuration. The associated AP 110 may generate and deliver any number of AIDs in one round, representing a set of identifiers intended for use across a corresponding number of EDP epochs. In some embodiments, after the assigned AIDs are exhausted or have expired (e.g., due to STA inactivity or extended session duration), the STA 105-1 may transmit a request to the associated AP 110 for additional AIDs. The request may occur through a management frame or as part of an existing association context. In response, the AP generates a new batch of AIDs and delivers them to the STA 105-1 via an action frame. In some embodiments, the action frame including the new AIDs may be protected or encrypted using cryptographic keys previously established during the 4-way handshake. Such protection preserves the confidentiality and integrity of the updated AID list under the EDP framework.

As used herein, the initial association and roaming (or (re)association) refers to the process of establishing one or more wireless communications links between a STA and an AP. This includes scenarios involving both single-link and multi-link devices. For single-link device, the association involves establishing a single logical link with the AP. For multi-link devices (MLDs), the association or roaming procedure may involve the negotiation and setup of multiple concurrent links across different channels or bands.

FIG. 2 depicts an example of client roaming where an AID list is included in a (re)association response, according to some embodiments of the present disclosure.

As depicted, a STA 205-1 is engaged in a roaming operation to AP 210-2. The STA 205-1 may correspond to STA 105-1 as depicted in FIG. 1, and the AP 210-2 may correspond to AP 110-2 as depicted in FIG. 1.

As shown, the AP 210-2 completes the roaming procedure by responding with a roaming response 215 at time t₁, which occurs near the end of EDP epoch 2. As used herein, the roaming response may refer to various types of management response, including a (re)association response, an Add Link response or a Delete Link response.

In one embodiment, the AP 210-1 may include only the current AID (e.g., AID 2 for Epoch 2) in the response 215 and send the full list of upcoming AIDs in a separate action frame. However, this approach may result in a transient period (e.g., 150 of FIG. 1) during which the STA 205-1 lacks a valid AID if the action frame is delayed past the start of the next epoch.

In the embodiment depicted in FIG. 2, AP 110-2 includes the full AID list element directly in the (re)association response (also referred to in some embodiments as the roaming response) 215. The AID List element includes pre-assigned AIDs intended for use in upcoming EDP epochs. As shown, the element includes several fields, including an Element ID field 220, a Length field 225, an Element ID Extension field 230, a Group ID field 235, a Start Epoch (SE) field 240, and an AID List Value field 245. The Element ID field 220 identifies the type of the information element. The Length field 225 indicates the total length of the element in bytes. The Element ID Extension field 230 is used to support extended identification beyond the base Element ID space. The Group ID field 235 indicates the EDP group context to which the listed AID applies. The SE field 240 defines the first epoch for which the listed AIDs are valid. The AID List Value field 245 includes the actual sequence of AIDs (e.g., AIDs 1 to N). In the example shown, since the roaming response is transmitted during epoch 2, the SE is set to 2, and the AID list begins with AID 2.

Because the full list is delivered as part of the (re)association completion, the STA 205-1 is already provisioned with a valid AID (e.g., AID 3) for the next epoch (e.g., Epoch 3) before that epoch begins. As illustrated, epoch 3 starts at time t₂, after the roaming request was sent at t₁. Since AID 3 was already delivered via the AID List element in the roaming response 215, the STA 205-1 can continue data transmission into epoch 3 without interruption.

The disclosed embodiment eliminates the transient pause in data transmission caused by delays in action frame delivery. The disclosed approach thus improves the reliability of roaming procedures and offers improved performance for latency-sensitive applications.

In some embodiments, the AP 210-2 may reduce the size of the AID list included in the (re)association response based on the expected duration of the STA’s 205-1 presence and/or the length of the EDP epochs. The AP may predict how long the STA is likely to remain connected by analyzing historical association patterns for that device, such as previous session durations or roaming frequency. In some embodiments, machine learning techniques may be used to infer the expected stay duration using features such as time of day, device type, service usage history, and signal stability metrics. For example, if the STA is expected to remain connected for a short time (e.g., from epoch 2 to epoch N-5), or if the epochs themselves are short in duration, the AP 210-2 may include only a small subset of AIDs (e.g., AID 2 through AID N-5) within the roaming response. The optimization reduces the computational and memory overhead involved in generating and transmitting large AID lists.

In some embodiments, the AID list size provided in the response is configured to not exceed the STA’s processing or memory limitations. The STA’s maximum acceptable AID list size may be explicitly indicated during capability exchange or included in the roaming request. In such configurations, the AP may limit the size of the provided AID list to not exceed the indicated maximum size.

In some embodiments, the AID List element is delivered in Message 3 (M3) of the 4-way handshake (4W HS). M3 is encrypted and occurs after key establishment. Therefore, including the AID List element within M3 improves the data protection of the AID provisioning operation. This approach ensures that the AID list is not exposed in plaintext during early stages of association.

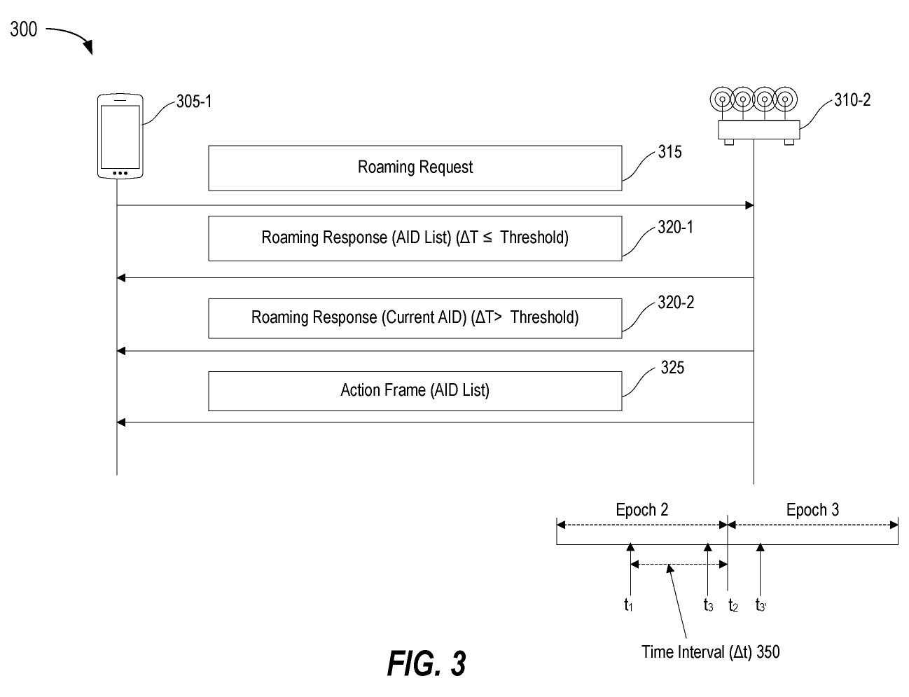

FIG. 3 depicts an example 300 of client roaming where an AID list is conditionally provisioned based on proximity to an epoch boundary, according to some embodiments of the present disclosure.

As depicted, a STA 305-1 is engaged in a roaming operation to AP 310-2. The STA 305-1 may correspond to STA 105-1 as depicted in FIG. 1, and the AP 310-2 may correspond to AP 110-2 as depicted in FIG. 1.

In the example 300 shown, STA 305-2 transmits a roaming request to AP 310-2 at time t₁ during EDP epoch 2. Upon receiving the request, AP 310-2 evaluates the time interval (Δt) 350 between t₁ (when the roaming request is received) and t₂ (the start of epoch 3). The interval 350 is compared to a predefined threshold to determine whether to include an AID list in the roaming response or to deliver it later via a separate action frame.

The threshold may be determined based on a variety of network-specific parameters, such as estimated action frame delivery latency, processing delay at the STA 305-1, and a safety margin to ensure AID availability prior to the epoch transition. In some embodiments, the threshold may be statically configured in time units (e.g., microseconds, milliseconds, or Time Units (TUs)). In some embodiments, the threshold may be dynamically adjusted based on link conditions, AP load, or negotiated capabilities.

If the time interval (Δt) 350 is less than or equal to the threshold, AP 310-2 determines that the remaining time in epoch 2 is insufficient to guarantee timely delivery of an action frame before epoch 3 begins. As a result, AP 310-2 includes the AID List element directly in the roaming response 320-1. The inclusion of the full AID list ensures that STA 305-1 receives not only the current AID for epoch 2 but also one or more subsequent AIDs (e.g., AID 3for epoch 3) without delay. In this case, if the full list were not included and the action frame was transmitted later at time t_{3’} (after epoch 3 has already begun), the STA 305-1 may lack a valid AID during the interval between t₂ and t_{3’} and prevent it from transmitting data to AP 310-2.

If the time interval (Δt) 350 exceeds the threshold, the AP 310-2 determines that there is sufficient time to deliver the AID list via an action frame 325 before the next epoch begins. In this configuration, the roaming response 320-2 includes only the current AID (e.g., AID 2), and the full AID list is transmitted separately at time t₃. As depicted, t₃falls within epoch 2 and precedes the transition at t₂. The conditional AID provisioning mechanism enables the AP 310-2 to intelligently select the appropriate delivery method and timing for AID distribution. This approach avoids unnecessary overhead under favorable conditions (e.g., when there is sufficient time remaining in the current epoch to deliver the protected action frame) and reduces the risk of STA-side transmission gas across EDP epoch boundaries. Furthermore, because the action frame is protected using a cryptographic key established during the 4-way handshake, it provides improved security compared to unprotected management responses. Therefore, when sufficient time is available, delivering the AID list via a protected action frame is more desirable from the privacy standpoint.

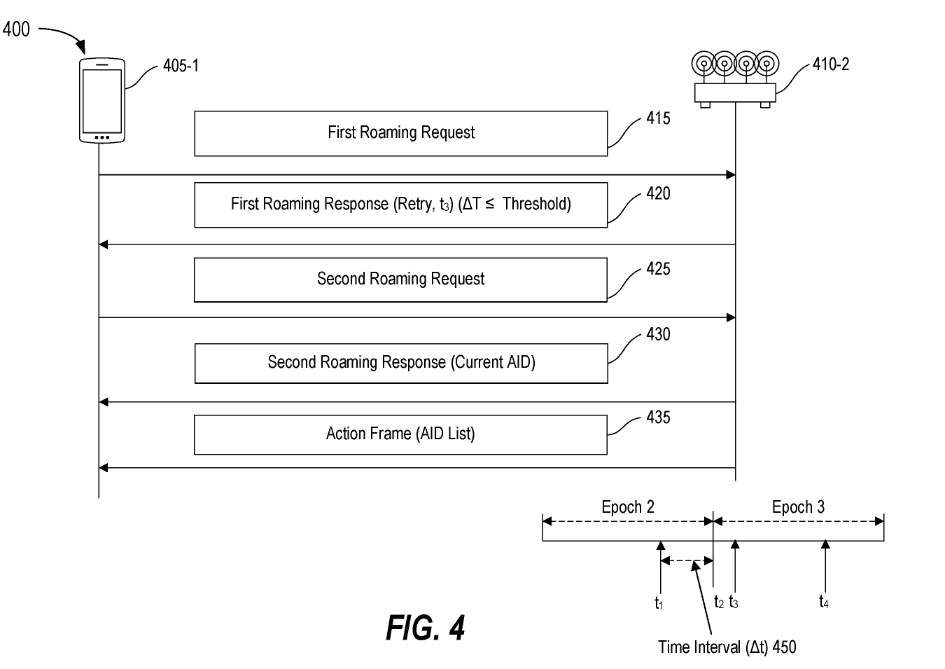

FIG. 4 depicts an example 400 of client roaming where an AP responds with a retry indication, according to some embodiments of the present disclosure.

In the example 400 as shown, the AP 410-2 responds with a retry status code when the (re)association is attempted too close to the end of an EDP epoch. The STA 405-1 may correspond to STA 105-1 as depicted in FIG. 1, and the AP 410-2 may correspond to AP 110-2 as depicted in FIG. 1.

As depicted, STA 405-1 initiates roaming by transmitting a first roaming request to AP 410-2 at time t₁, which is near the end of EDP epoch 2. Upon receiving the request, AP 410-2 determines whether the remaining time in the current epoch, such as the time interval (Δt) 450 between t₁ and t₂ (the start of EDP epoch 3), is less than or equal to a predefined threshold. The threshold may be determined based on expected timing requirements for AID delivery, including potential delays associated with action frame transmission or STA-side processing.

If the interval 450 is less than or equal to the threshold, the AP determines that the request is too close to the end of epoch 2 to allow for reliable AID provisioning. In this case, AP 410-2 responds with a roaming response 420 (also referred to in some embodiments as a (re)association response) that includes a retry status code, along with a comeback value indicating when the STA should retry its request. The comeback value, marked as t₃, may be set equal to t₂ or slightly later, considering any EDP transition period that may occur at the beginning of epoch 3.

If the interval 450 is greater than the threshold, the AP 410-2 proceeds with association. In this case, AP 410-2 sends a response (not shown) including the current AID (e.g., AID 2 for epoch 2), and subsequently transmits the full AID list in a separate action frame (not shown) before the start of epoch 3.

Returning to the retry embodiment, upon receiving the first response 420 with the retry indication, STA 405-2 waits until time t₃ and then transmits a second roaming request 425 during epoch 3. The AP 410-2 repeats the same evaluation. Assuming there is sufficient time before the end of epoch 3, AP 410-2 this time completes the association by sending a second response 430 including AID 3, which is valid for epoch 3. The full AID list is then delivered in an action frame 435 at time t₄ during epoch 3.

The retry mechanisms with controlled timing avoid associations that would otherwise result in a STA receiving an AID valid only for a few milliseconds before expiration. Compared to the embodiments as depicted in FIGS. 2-3, where the roaming procedure completes immediately and AID provisioning is embedded in or timed relative to the association response, this approach may introduce a short delay in roaming completion. However, it also provides benefits in that the STA resumes association at the start of a fresh epoch. This offers maximum (or at least increased) utility of the assigned AID and increases the likelihood that any subsequent action frame carrying the full AID will be delivered within the valid time window.

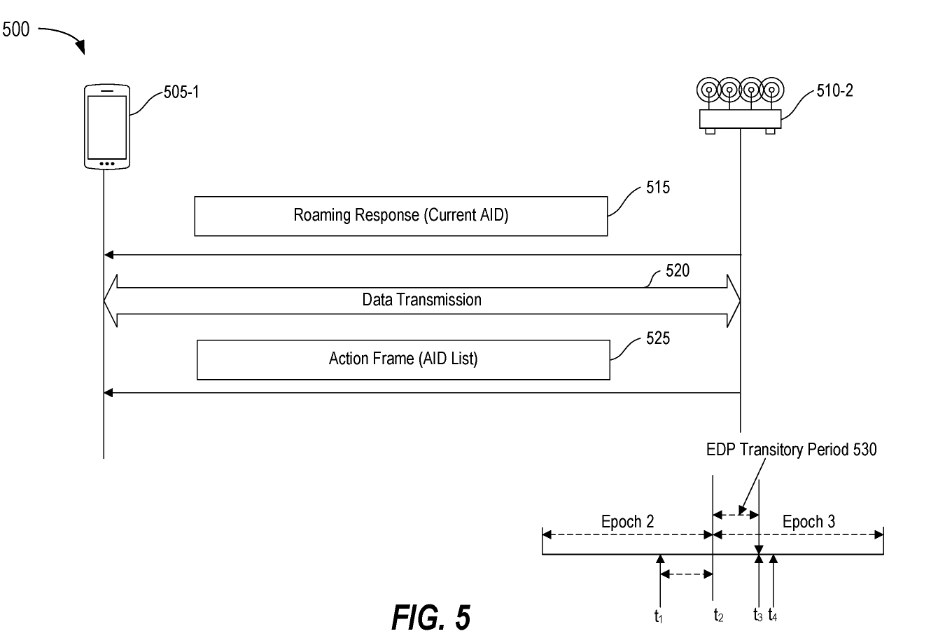

FIG. 5 depicts an example 500 of client roaming where an EDP transitory period is extended to allow data transmission prior to AID list delivery, according to some embodiments of the present disclosure.

As depicted, STA 505-1 roams to AP 510-2 and receives a roaming response 515 at time t₁ during epoch 2. The response includes the current AID (e.g., AID 2) valid for epoch 2. The current AID sharing enables the STA 505-1 to continue data transmission during the remaining portion of this epoch. As shown, between t₁ and t₂ (the start of epoch 3), the STA 505-1 transmits or receives data using the assigned AID₂ under normal EDP operation (as depicted by 520). The STA 505-1 may correspond to STA 105-1 as depicted in FIG. 1, and the AP 510-2 may correspond to AP 110-2 as depicted in FIG. 1.

Within EDP networks, an EDP transitory period is defined near the boundary of consecutive epochs, either at the end of one epoch or the beginning of the next. During the short interval, frame transmission is typically restricted to retransmission and acknowledgements of previously sent frames.

In the example 500, the EDP transitory period 530 occurs at the beginning of epoch 3. To avoid a temporary communication gap during which the STA 505-1 lacks a valid AID, the period 530 is extended in scope. As depicted, the EDP transitory period 530 at the start of epoch 3 is extended to permit new data frame transmission from the STA 505-1 that has not yet received a valid AID for the new epoch.

The extension allows STA 505-1 to continue communicating through the transition from t₂ (the start of epoch 3) and t₃ (the end of the EDP transitory period), even though the full AID list (including AID 3) has not yet been received. The AP 510-2 subsequently transmits an action frame 525 at time t₄, around or slightly after the transitory period has ended. The action frame 525 delivers the full AID list for use in epoch 3 and beyond. In some embodiments, the action frame 525 may be sent during the transitory period before t₃.

Once STA 505-1 receives the action frame, STA 505-1 switches to using AID 3 for the remainder of epoch 3. The temporary permission to transmit during the EDP transitory period 530 bridges the timing gap and provides uninterrupted operation. The disclosed embodiment provides increased performance in scenarios where AID list delivery may be slightly delayed due to scheduling constraints, frame loss, or AP processing time.

In some embodiments, the EDP transitory period may occur at the end of an epoch, such as at the end of epoch 2 and before the transition to epoch 3. In such configurations, the EDP transitory period is similarly extended to allow the STA 505-1 to transmit new data frames. The extension provides the similar benefit of mitigating communication gaps that could otherwise occur if the STA 505-1 lacks a valid AID for epoch 3 at the moment of transition. By allowing limited data transmission during this window, the network supports uninterrupted operation while waiting for the delivery of the updated AID list.

In some embodiments, when such extension is implemented, the AP 510-2 may also advertise the length of the EDP transitory period 530 to the non-AP MLD (e.g., STA 505-1), such as via the roaming response 515. To communicate the length information, AP 510 may use a specific field in the EDP Capability element or any other information element or management frame. The signaling allows the STA 505-1 to determine the exact endpoint of the transitory period and plan its transmission behavior accordingly. The transitory period length may be indicated using any suitable time representation, such as milliseconds, microseconds, time units (TU), or another value that can be consistently interpreted by the STA 505-1.

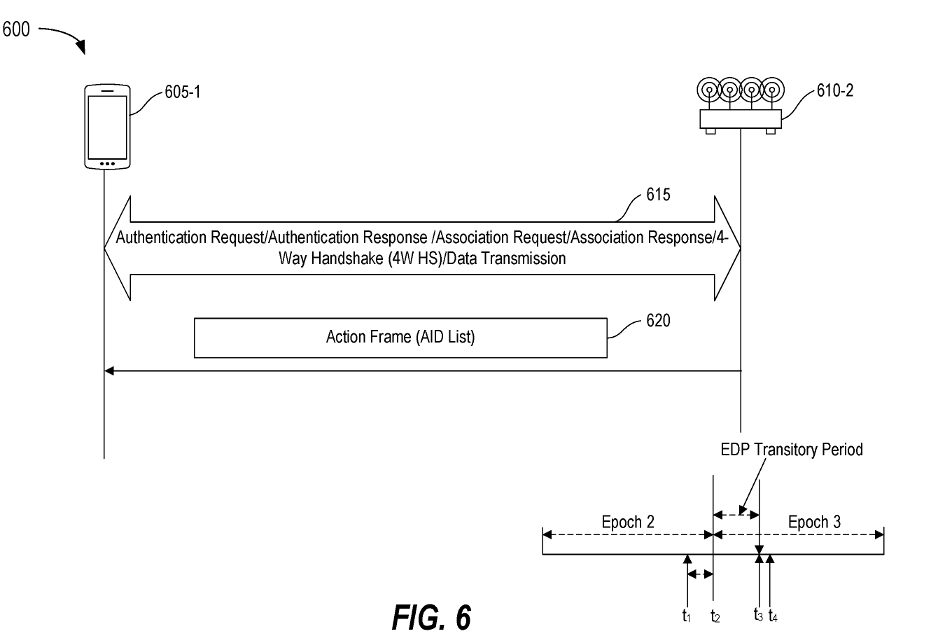

FIG. 6 depicts an example 600 of client roaming where an EDP transitory period is extended to allow full association choreography prior to AID list delivery, according to some embodiments of the present disclosure.

In this example 600, STA 605-1 roams to AP 610-2, and the (re)association process occurs close to the end of EDP epoch 2. The STA 605-1 may correspond to STA 105-1 as depicted in FIG. 1, and the AP 610-2 may correspond to AP 110-2 as depicted in FIG. 1. As discussed above, the EDP transitory period permits only retransmissions and acknowledgments (ACKs) within defined IEEE 802.11 networks. In the embodiment depicted in FIG. 6, the scope of the EDP transitory period is extended to allow complete association signaling and data frame transmission to proceed even in the absence of a valid AID for the new epoch.

As shown, the roaming or association procedures initiate at time t₁, near the end of epoch 2. The sequence may include one or more of the following steps: authentication request and response, (re)association request and response, and the 4-way handshake messages. Epoch 3 begins at time t₂, and the EDP transitory period spans from t₂ to t₃. In this embodiment, the entire association choreograph 615 is permitted to continue seamlessly across the epoch boundary, without requiring the STA 605-1 to pause or wait for AID reassignment. Once the association is completed and one or more communication links have been established, in some embodiments, data transmission is also allowed during the extended EDP transitory period.

As depicted, an action frame 620 carrying the full AID list may arrive at time t₄, once the transitory period concludes. In some embodiments, the action frame 625 may arrive earlier than t₃ so that STA 605-1 can begin using AID 3 sooner without interruption. The disclosed embodiment ensures that both association and data-plane activities are fully supported across epoch transitions, even before new AIDs have been provisioned. This mechanism is particularly beneficial in scenarios where the (re)association (or roaming) procedure begins near the end of an epoch, and one or more remaining steps, such as the association response or 4-way handshake, are not yet completed before the epoch transition (e.g., from epoch 2 to epoch 3). Without the extended transitory period, such timing misalignment may otherwise leave the STA 605-1 without a valid AID for the new epoch and prevent it from completing association or initiating data transmission.

In some embodiments, the EDP transitory period may instead be defined at the end of epoch 2, prior to the transition to epoch 3. In such configurations, the transitory period is similarly extended to permit full association choreography and data transmission before the epoch boundary. The extension provides the similar benefit of mitigating communication gaps by enabling seamless progression through the remaining association steps and immediate post-association data exchange, even when the new AID has not yet been provisioned for the upcoming epoch.

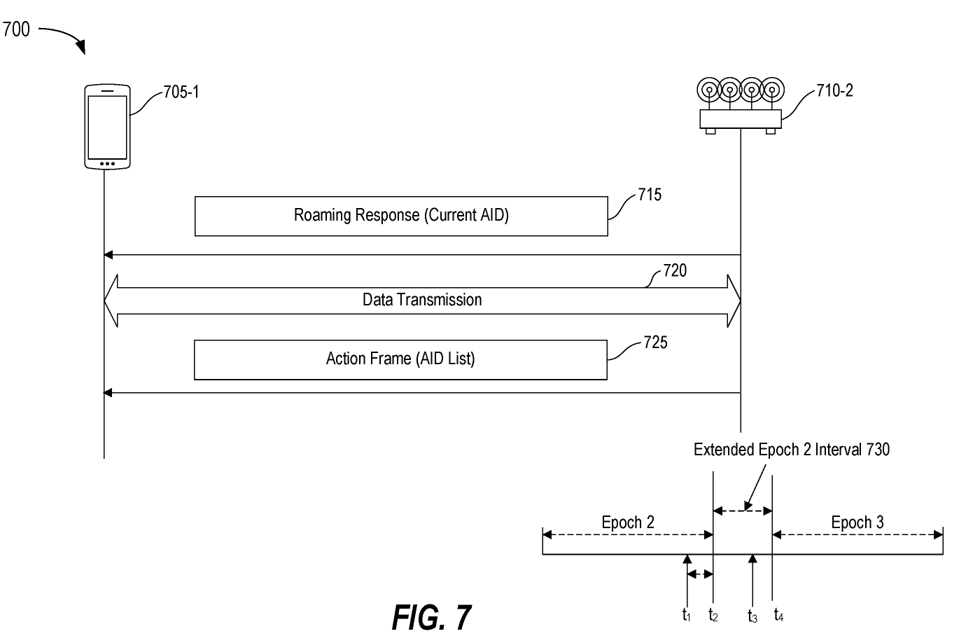

FIG. 7 depicts an example 700 of client roaming where a STA extends a current EDP epoch until valid AIDs are received, according to some embodiments of the present disclosure.

As depicted, a STA 705-1 roams to AP 710-2 and receives a roaming response 715 at t₁during epoch 2. The STA 705-1 may correspond to STA 105-1 as depicted in FIG. 1, and the AP 710-2 may correspond to AP 110-2 as depicted in FIG. 1. Under default EDP behavior, epoch 2 would originally end and epoch 3 would begin at time t₂. However, in this example 700, the STA 710-2 locally delays the start of epoch 3, extending the use of epoch 2 until the STA 705-1 receives valid AID(s) for the upcoming epoch.

As shown, the extended epoch 2 interval 730 spans from t₂ tot₄. During this interval, the STA 705-1 and AP 710-2 continue to operate and perform data transmission using the current AID (e.g., AID 2) (as depicted by 720). At time t₃, an action frame 725 is received from AP 710-2. The action frame 725 includes the full AID list, including AID 3 for epoch 3. Once the AID list is received, the STA 705-1 transitions into epoch 3 at t₄. At time t₄, the STA 705-1 is provisioned with the correct AID (e.g., AID 3) for data transmission.

The STA’s behavior of deferring the local epoch transition avoids the state where the STA 705-1 would otherwise lack a valid AID between the scheduled end of epoch 2 (t₂) and the actual receipt of AID list at t₃. The disclosed embodiment is useful in networks where action frame latency is unpredictable, or in environments with high congestion or short epoch duration. In such configurations, the ability for the STA 705-1 to defer its epoch transition locally until it receives the necessary AIDs helps maintain stable operation and minimize (or at least reduce) the risk of data-plane interruptions during roaming.

In some embodiments, the STA may indicate its deferral behavior to the AP 710-2, such as through an information field in a management frame or an extension element included in the (re)association request or subsequent signaling exchange. Upon receiving the indication, the AP may adjust its AID provisioning strategy or scheduling behavior to improve coordination with the STA and further reduce the likelihood of identifier mismatches across the epoch boundary.

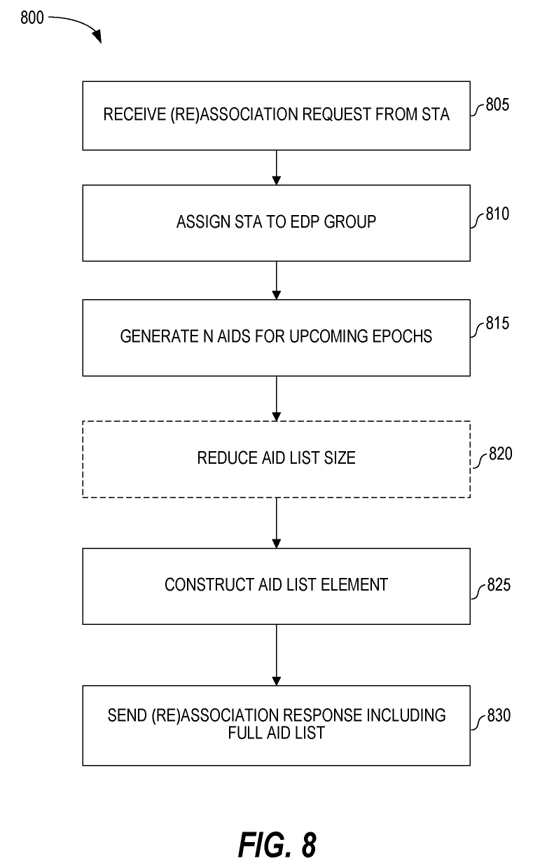

FIG. 8 depicts an example method 800 for AID list provisioning in a (re)association response, according to some embodiments of the present disclosure.

The example method 800 may be performed by the AP 110-2 as depicted in FIG. 1, the AP 210-2 as depicted in FIG. 2, or other network devices configured to manage roaming and AID assignment for STAs in EDP environments.

At block 805, an AP (e.g., 210-2 of FIG. 2) receives a (re)association request (also referred to as a roaming request) from a STA (e.g., STA 205-1 of FIG. 2). The request may include capability indicators such as a maximum AID list size, which the AP may later consider during AID generation and assignment.

At block 810, the AP determines the EDP group to which the STA will belong. The decision may be based on the AP’s configuration, current load balancing across EDP groups, or pre-established criteria such as roaming agreements with the serving AP (e.g., 110-1 of FIG. 1). The group determines the structure of the AID rotation schedule and the pool of AIDs to be used.

At block 815, the AP generates a list of N AIDs for the STA, with each AID intended for use in a respective EDP epoch. The number of N may reflect a fixed configuration or a dynamically computed value based on the expected duration of the STA’s session. Each AID is uniquely derived to prevent correlation across epochs.

At block 820, the AP evaluates whether the full AID list should be reduced in size before being sent to the STA. This operation is optional and may depend on several factors, such as the expected duration of the STA’s presence in the basic service set (BSS), the length of the EDP epoch, or a maximum AID list size explicitly indicated by the STA in the (re)association request. Reducing the list size may also be desirable in environments with limited network resources to minimize (or at least reduce) computation and frame overhead.

At block 825, the AP constructs the AID List element using the generated AIDs and EDP group information. The element may include one or more fields to indicate the assigned EDP group, the start epoch (SE), and the sequence of AIDs to be used across epochs. The structure of the element may be formatted according to the protocol encoding rules defined in IEEE 802.11bi.

At block 830, the AP includes the constructed AID List element in the encrypted (re)association response (e.g., 215 of FIG. 2), and sends the response back to the STA. This operation ensures the STA receives all necessary AIDs for future epochs immediately upon association completion, avoiding any delays caused by separate action frame delivery.

In some embodiments, instead of including the AID List element in the (re)association response, the AP may include the element in M3 of the 4-way handshake. M3 is exchanged after key establishment and is encrypted, making it a secure vehicle for delivering privacy-sensitive information such as future AIDs.

The workflow illustrated in FIG. 8 is provided as one example for conceptual clarity. In some embodiments, these operations in blocks 810 through 825 may occur in parallel or in a different sequence. For example, the AP may begin constructing the AID List element concurrently with the generation of AIDs. Such variations remain within the scope of the disclosed embodiment, as long as the STA is provided with a valid AID list for upcoming epochs.

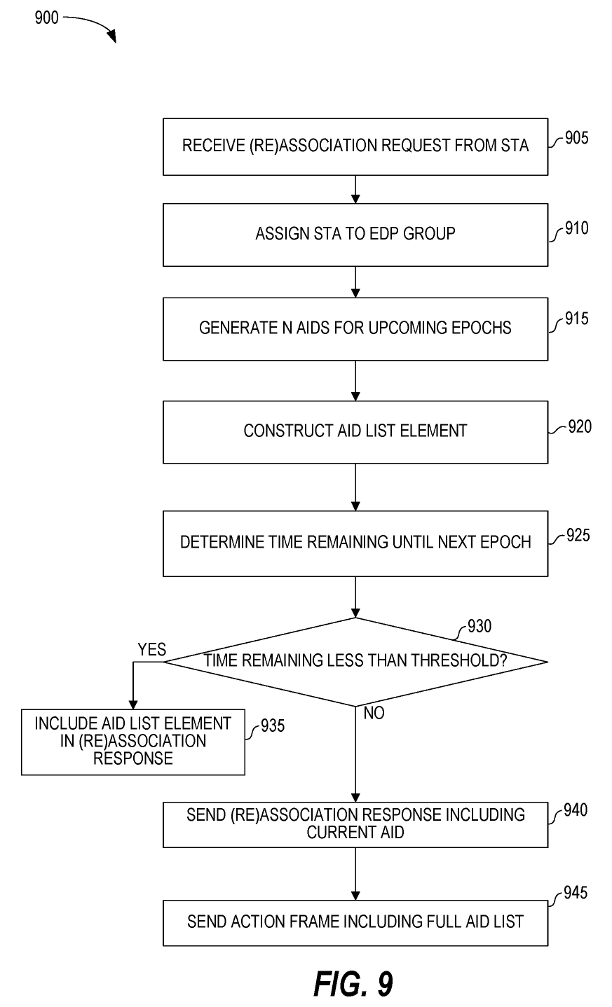

FIG. 9 depicts an example method 900 for conditionally AID list provisioning based on epoch proximity, according to some embodiments of the present disclosure.

The example method 900 may be performed by the AP 110-2 as depicted in FIG. 1, the AP 310-2 as depicted in FIG. 3, or other network devices configured to manage roaming and AID assignment for STAs in EDP environments.

At block 905, an AP (e.g., 310-2 of FIG. 3) receives a (re)association request from a STA (e.g., 305-1 of FIG. 3). The response may be part of a new association or a roaming event. The STA may include parameters such as its maximum supported AID list size within the request.

At block 910, the AP determines the EDP group to which the STA will be assigned. The EDP group controls epoch alignment and AID rotation timing. The group may be selected based on interval policy or backend coordination across APs.

At block 915, the AP generates a list of N AIDs for the STA, where each AID corresponds to a future EDP epoch. The value of N may be based on system defaults, the STA’s expected session length, or explicit list size constraints provided by the STA (e.g., in the (re)association request).

At block 920, the AP constructs the AID List element using the generated AIDs and the EDP grouping information. The element includes fields such as Element ID, Length, Element ID Extension, Group ID, Start Epoch (SE), and AID List Value.

At block 925, the AP calculates the remaining time until the next EDP epoch begins. More specifically, if the (re)association request is received at time t₁and the current EDP epoch is scheduled to end at time t₂, the AP computes the time interval between t₁ and t₂. The interval (e.g., 350 of FIG. 3) reflects how much time is available before the STA requires a new AID for the next epoch. The result of the calculation is then used to determine whether there is enough time to deliver the AID list separately via an action frame, or whether it needs to be included immediately in the (re)association response.

At block 930, the AP compares the remaining time to a predefined threshold value. The threshold is used to determine whether there is sufficient time to deliver the AID list in a separate action frame before the next epoch transition. If the remaining time is less or equal to the threshold, the method proceeds to block 935, where the AP includes the full AID List element directly in the (re)association response (e.g., 320-1 of FIG. 3) and send the response to the STA. The response completes the link association and provides the STA a full AID list for upcoming epochs. The direct sharing avoids transmission pause or delay at the epoch boundary.

If the remaining time exceeds the threshold, the method proceeds to block 940, where the AP includes only the current AID in the response (e.g., 320-2 of FIG. 3) and sends it to the STA. At block 945, the AP then provides the full AID list in a separate action frame (e.g., 325 of FIG. 3).

The workflow illustrated in FIG. 9 is provided as one example for conceptual clarity. In some embodiments, upon receiving the (re)association request, the AP may first determine the remaining time until the next EDP epoch and compare it with the threshold before proceeding with other steps. Based on the result of the comparison, the AP may then decide whether it needs to generate and deliver a full AID list immediately. The operations of EDP group assignment, AID generation, and AID List element construction may occur sequentially or in parallel if the AP determines that inclusion of the AID list is needed either within a response or an action frame. Such variations remain within the scope of the disclosed embodiment, as long as the STA is ultimately provisioned with both a current AID and a valid AID list for upcoming epochs.

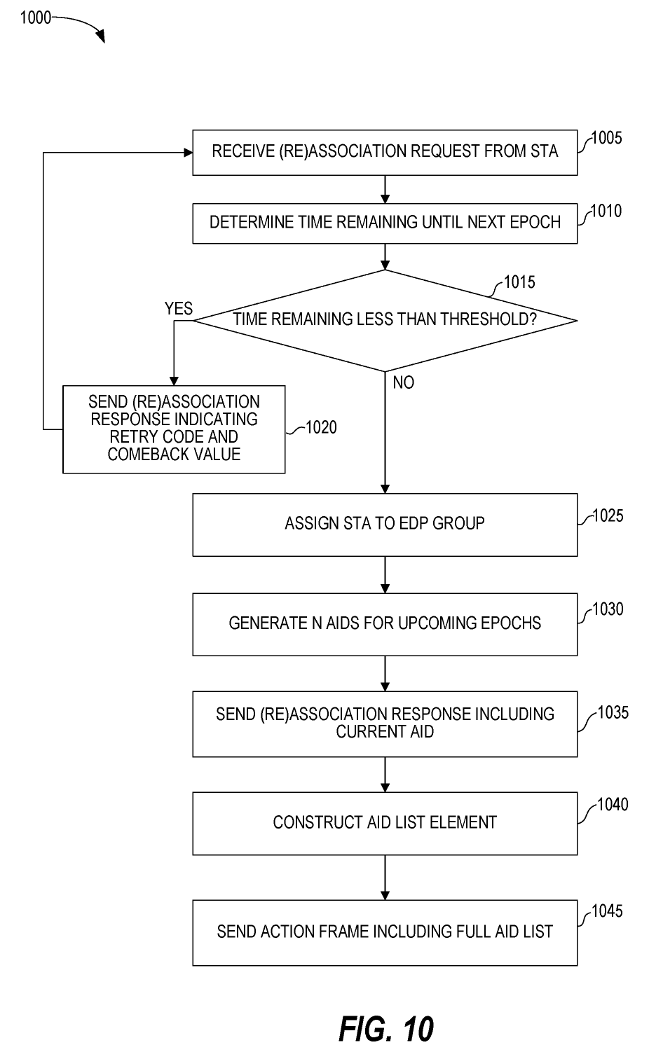

FIG. 10 depicts an example method 1000 for AID provisioning with a retry-based association, according to some embodiments of the present disclosure.

The example method 1000 may be performed by the AP 110-2 as depicted in FIG. 1, the AP 410-2 as depicted in FIG. 4, or other network devices configured to manage roaming and AID assignment for STAs in EDP environments.

At block 1005, an AP (e.g., 410-2 of FIG. 4) receives a (re)association request (e.g., 415 of FIG. 4) from a STA (e.g., 405-1 of FIG. 4). This may occur during roaming, when the STA is moving across APs.

At block 1010, the AP determines the time remaining until the next EDP epoch begins. More specifically, the AP calculates the time interval between the time the request is received (e.g., t₁ as depicted in FIG. 4) and the scheduled epoch boundary (e.g., t₂as depicted in FIG. 4).

At block 1015, the AP compares the interval to a defined threshold. The threshold may be determined based on known delays associated with action frame transmission and STA-side processing.

If the time remaining is less than or equal to the threshold, the method proceeds to block 1020, where the AP rejects the (re)association attempt with a retry response (e.g., 420 of FIG. 4). The response includes a retry status code and a comeback value (e.g., t₃ as depicted in FIG. 4), which indicates when the STA should retry association (typically at or shortly after the beginning of the next epoch). When the STA retries association at the indicated time, the method returns to block 1005 to process the new request.

If the time remaining is greater than the threshold, the AP proceeds to block 1025, where it assigns the STA to an appropriate EDP group.

At block 1030, the AP generates a list of N AIDs, one for each upcoming EDP epoch. These AIDs are assigned uniquely for the STA and may be generated based on the EDP group’s epoch schedule.

At block 1035, the AP includes the current AID (e.g., AID 2) in the (re)association response (e.g., 430 of FIG. 4) and sends it to the STA to complete the association.

At block 1040, the AP constructs the AID List element using the generated AIDs and EDP grouping information, including fields such as the Start Epoch (e.g., Epoch 2) and AID List Value (which includes the actual sequence of AIDs).

At block 1045, the AP includes the constructed AID List element in a separate action frame (e.g., 435 of FIG. 4), which is transmitted to the STA to deliver future AIDs (e.g., AID 3for epoch 3 and beyond).

The depicted sequence of operations in blocks 1025 through 1045 is provided for conceptual clarity. In some embodiments, these operations may occur in parallel or in a different sequence. For example, the AP may begin constructing the AID List element concurrently with the generation of AIDs, or the AP may generate only the current AID first, send the (re)association response to the STA, and defer generating the remaining AIDs and constructing the full AID list until afterward, before delivering them in a separate action frame. Such variations remain within the scope of the disclosed embodiment, as long as the STA is ultimately provided with both a current AID and a valid AID list for upcoming epochs.

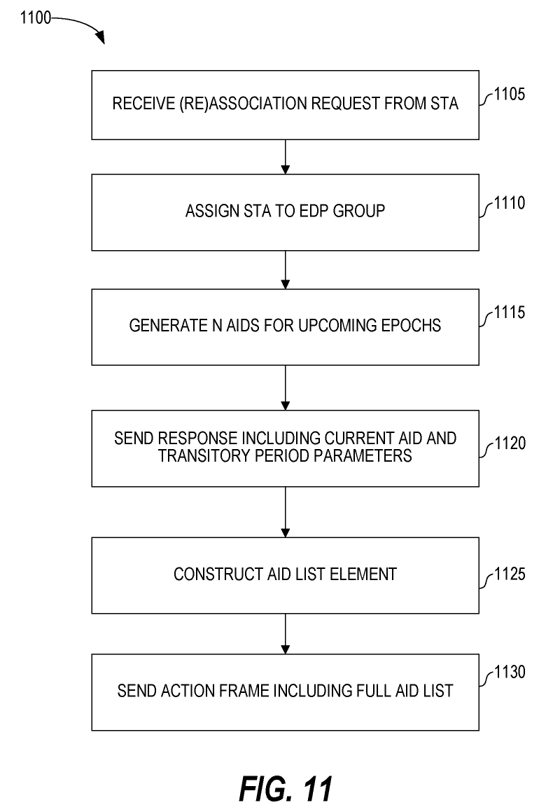

FIG. 11 depicts an example method 1100 for AID provisioning with EDP transitory period extension, according to some embodiments of the present disclosure.

The example method 1100 is used by an AP to support uninterrupted association and data-plane operation across EDP epoch boundaries by extending the EDP transitory period. The example method 1100 may be performed by the AP 110-2 as depicted in FIG. 1, the AP 510-2 as depicted in FIG. 5, the AP 610-2 as depicted in FIG. 6, or other network devices configured to manage roaming and AID assignment for STAs in EDP environments.

At block 1105, an AP (e.g., AP 510-2 of FIG. 5 or AP 610-2 of FIG. 6) receives a (re)association request from a STA (e.g., STA 505-1 of FIG. 5 or STA 605-1 of FIG. 6), either during an initial join or as part of a mobility-triggered roaming event.

At block 1110, the AP assigns the STA to an EDP group, which defines the STA’s epoch schedule, AID rotation behavior, and any privacy limitations applicable to the session.

At block 1115, the AP generates a list of N AIDs to be used by the STA in upcoming EDP epochs. Each AID corresponds to a future epoch, and the list may be generated according to local policy or STA-specified parameters.

At block 1120, the AP sends a (re)association response that includes the current AID valid for the active epoch (e.g., AID 2), the advertised length of the EDP transitory period, and an indication that specific operations are permitted during the transitory period, such as data transmission or full association message exchange (e.g., authentication request/response, (re)association request/response, 4-way handshake messages). The advertised behavior modifies the STA’s normal transitory period expectations, which by default limit transmissions to retransmissions and ACKs. By extending the window and signaling the permitted actions, the AP enables the STA to operate without interruption even if new AIDs for the next epoch have not yet been delivered.

At block 1125, the AP constructs the AID List element using the previously generated AIDs. The element includes the SE, AID List Value, and other relevant protocol fields.

At block 1130, the AP sends an action frame including the AID List element to the STA. The frame may be transmitted during the EDP transitory period (e.g., between t₂ and t₃ as depicted in FIGS. 5 and 6), or shortly after the transitory period ends. In either case, the timing is close enough to avoid any meaningful or obvious disruption in STA operation. The STA, already permitted to transmit during the extended transitory window, can seamlessly adopt the new AID for epoch 3 as soon as the action frame is received.

The depicted sequence of operations is presented for conceptual clarity. In some embodiments, some operations may occur in parallel, or in a different order. For example, the AP may begin constructing the AID List element before sending the (re)association response, or may pipeline AID generation and element construction while preparing the action frame. Such variations remain within the scope of the disclosed embodiments, as long as the STA is appropriately provisioned during the EDP transitory period.

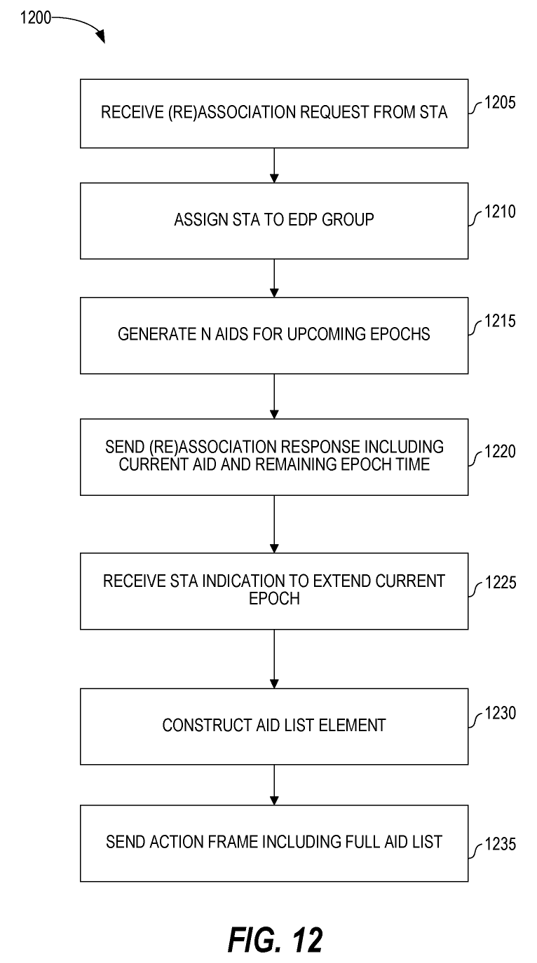

FIG. 12 depicts an example method 1200 for AID provisioning in response to a STA-initiated epoch extension, according to some embodiments of the present disclosure.

The example method 1200 is performed by an AP in response to a STA-initiated extension of the current EDP epoch. In this embodiment, the STA determines it has not yet received valid AIDs for the next epoch and chooses to extend the current epoch with the target AP. The example method 1200 may be performed by the AP 110-2 as depicted in FIG. 1, the AP 710-2 as depicted in FIG. 7, or other network devices configured to manage roaming and AID assignment for STAs in EDP environments.

At block 1205, an AP (e.g., AP 710-2 of FIG. 7) receives a (re)association request from a STA (e.g., STA 705-1 of FIG. 7). The request may initiate a new session or represent a roaming event near the end of an ongoing epoch.

At block 1210, the AP assigns the STA to an EDP group based on group scheduling and roaming policy.

At block 1215, the AP generates a set of AIDs for the STA, each intended to be used in the current or upcoming EDP epochs.

At block 1220, the AP sends a (re)association response that includes the current AID and/or an indication of the remaining time in the current epoch (e.g., expressed in TUs or milliseconds). The information allows the STA to evaluate whether there is sufficient time left in the current epoch to operate normally, or whether it should extend its use of the current epoch until new AIDs for the next epochs arrive. The timing information supports STA-side logic to delay or adjust the local epoch transition.

At block 1225, the AP receives an indication from the STA that it will delay transition to the next epoch until a specific time (e.g., t₄ as depicted in FIG. 7). The indication may be transmitted via a management frame and included within a field in the EDP Capability element.

At block 1230, the AP constructs the AID List element, using the previously generated AIDs.

At block 1235, the AP sends an action frame including the full AID list to the STA. The STA then uses the information to begin operation in the next epoch. The action frame may be sent before the specified time at which the STA plans to enter the next epoch.

The depicted sequence of operations is presented for conceptual clarity. In some embodiments, some operations may occur in parallel or in a different order. For example, the AP may construct the AID List element before sending the (re)association response, or generate AIDs while receiving the STA’s indication to extend the current epoch.

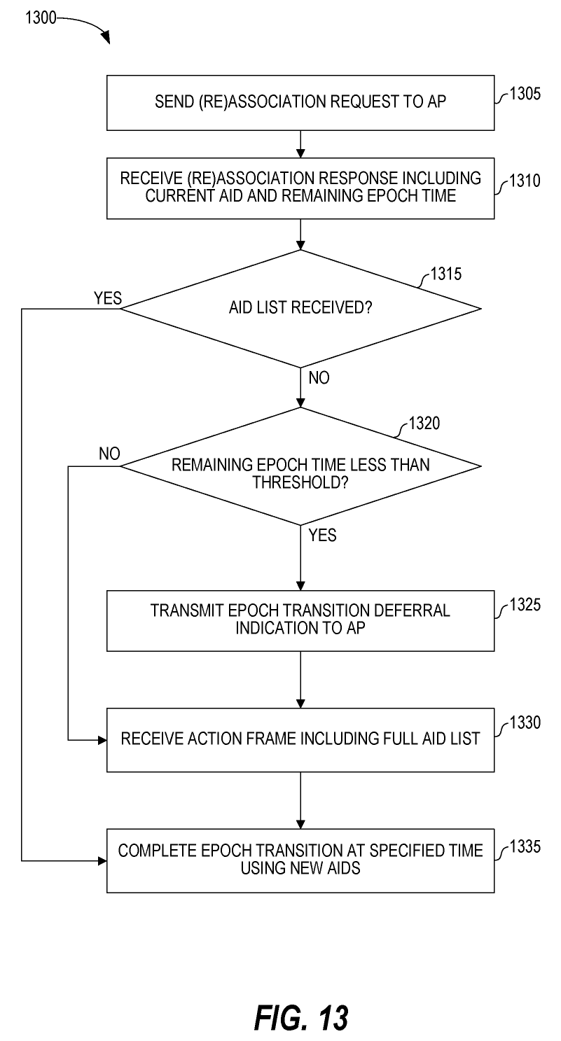

FIG. 13 depicts an example method 1300 for STA-initiated epoch extension, according to some embodiments of the present disclosure.

The example method may be performed by a client device or STA, such as the STA 705-1 as depicted in FIG. 7.

At block 1305, a STA transmits a (re)association request to a target AP, initiating a roaming event or new association session.

At block 1310, the STA receives a (re)association response that includes the current AID and the remaining time before the next epoch begins.

At block 1315, the STA determines whether it has already received the AID list for future epochs. If the list has been received, the STA transitions to the next epoch using the appropriate AID at the scheduled time (block 1335).

If the AID list has not yet been received, the method proceeds to block 1320, where the STA evaluates whether the remaining time before the next epoch is below a configured deferral threshold. The threshold may be determined based on link conditions or expected action frame latency.

If the time remaining exceeds the threshold, the STA determines that there is sufficient time to receive the AID list in a timely action frame. The method proceeds to block 1330, where the STA receives the action frame with the full AID list. At block 1335, the STA completes the epoch transition using the newly provisioned AID.

If the time remaining is less than or equal to the threshold, this indicates that there may be insufficient time for the STA to reliably receive the action frame carrying the AID list before the epoch transition occurs. In such configurations, the method proceeds to block 1325, where the STA transmits an epoch transition deferral indication. The message signals the STA’s intent to postpone transitioning to the next epoch until a specific future time (e.g., t₄ as depicted in FIG. 7). During the time between the original scheduled epoch boundary (e.g., t₂ as depicted in FIG. 7) and the specified deferral point, the STA and AP continue to use the current AID for data communication. This provides uninterrupted operation even though the STA has not yet adopted a new AID for the next epoch.

At block 1330, the STA receives the action frame from the AP including the full AID list, including the AID for the next epoch. Then, at block 1335, the STA completes the epoch transition at the STA-specified deferral time, and adopts the newly received AID in accordance with the EDP identifier rotation policy.

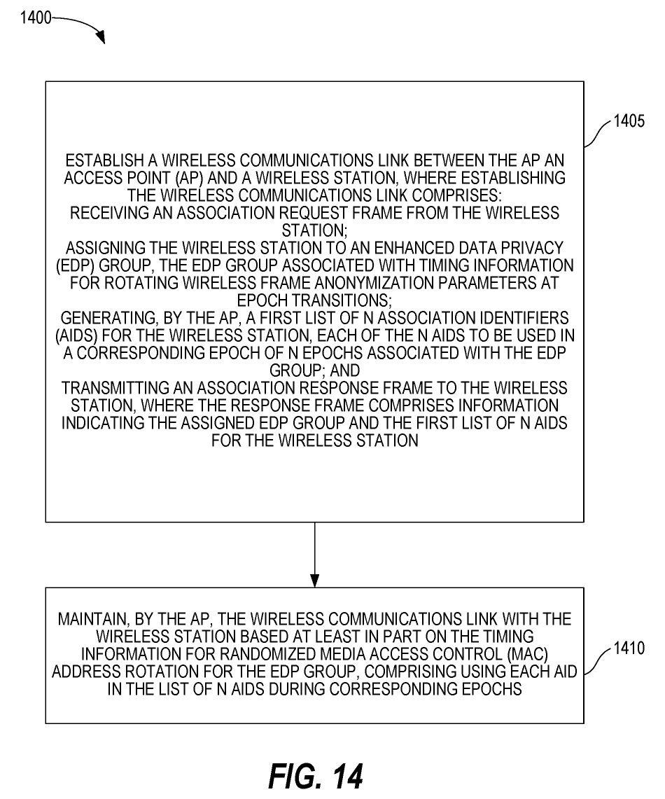

FIG. 14 is a block diagram depicting an example method for AID assignment during roaming, according to some embodiments of the present disclosure.

At block 1405, an AP (e.g., 110-2 of FIG. 1) establishes a wireless communications link between the AP and a station (e.g., 105-1 of FIG. 1). The operation of establishing the wireless communications link comprises receiving an association request frame from the wireless station, assigning the wireless station to an Enhanced Data Privacy (EDP) group, the EDP group associated with timing information for rotating wireless frame anonymization parameters at epoch transitions, generating, by the AP, a first list of N association identifiers (AIDs) for the wireless station, each of the N AIDs to be used in a corresponding epoch of N epochs associated with the EDP group, and transmitting an association response frame to the wireless station, where the response frame comprises information indicating the assigned EDP group and the first list of N AIDs for the wireless station.

At block 1410, the AP maintains the wireless communications link with the wireless station based at least in part on the timing information for randomized media access control (MAC) address rotation for the EDP group, comprising using each AID in the list of N AIDs during corresponding epochs.

In some embodiments, the AP generates a second list of X association identifiers (AIDs) for the wireless station, each of the X AIDs to be used in a corresponding epoch of X epochs associated with the EDP group, and transmits, to the wireless station in a protected wireless action frame, information indicating the second list of X AIDs for the wireless station.

In some embodiments, X is greater than N.

In some embodiments, the AP further provides a first communication indicating that the AP supports a randomized Media Access Control (MAC) address rotation management protocol.

In some embodiments, the association request frame comprises a protected association request frame that comprises rotation pace preference information for randomized Media Access Control (MAC) address rotation management, and the rotation pace preference information indicates a preferred rotation pace.

In some embodiments, the AIDs in the list of N AIDs are assigned from a preexisting range of AIDs.

In some embodiments, each AID in the list of N AIDs is to be used in a corresponding epoch of a set of future, consecutive epochs.

In some embodiments, each AID in the list of N AIDs is unique to the wireless station during an epoch corresponding to the AID.

In some embodiments, before an end of the X epochs, the AP generates a third list of association identifiers (AIDs) for the wireless station, each of the AIDs to be used in a corresponding epoch associated with the EDP group, and transmits, to the wireless station in a second protected wireless frame, information indicating the third list of AIDs for the wireless station.

In some embodiments, the AP further receives a wireless frame indicating a request for a new list of AIDs.

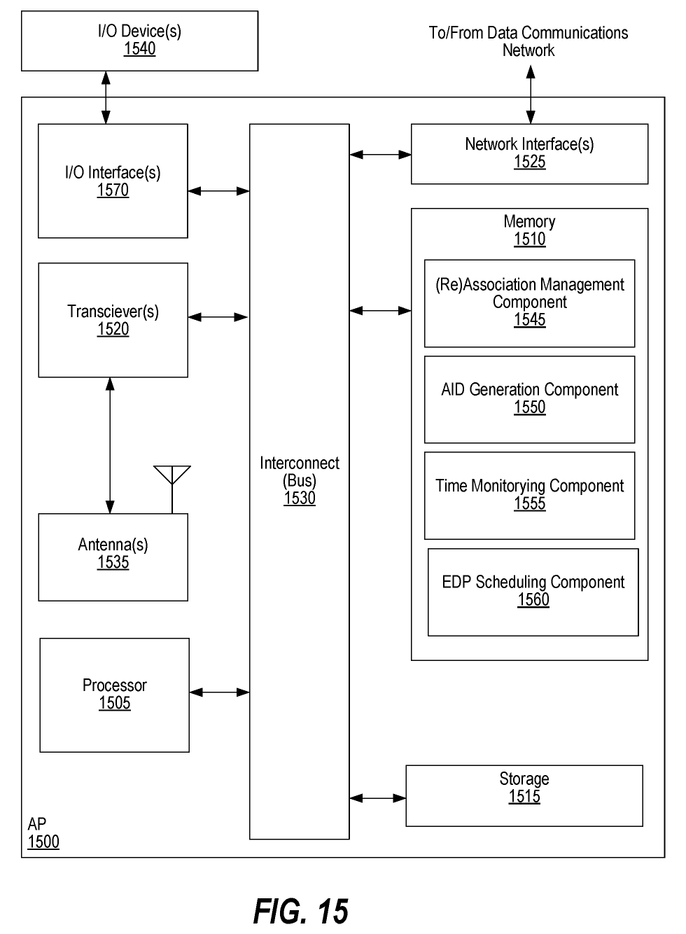

FIG. 15 depicts an example network device 1500 configured to perform various embodiments of the present disclosure, according to some aspects of the present disclosure. The example network device 1500 may correspond to a target AP, such as AP 110-2 as depicted in FIG. 1, AP 210-2 as depicted in FIG. 2, AP 310-2 as depicted in FIG. 3, AP 410-2 as depicted in FIG. 4, AP 510-2 as depicted in FIG. 5, AP 610-2 as depicted in FIG. 6, and AP 710-2 as depicted in FIG. 7. In some embodiments, the example network device 1500 may correspond to other devices configured to manage roaming and AID assignment for STAs in EDP environments, such as a network gateway, a physical or cloud-based server, or a wireless controller.

As illustrated, the network device 1500 includes a processor 1505, memory 1510, storage 1515, one or more transceivers 1520, one or more I/O interfaces 1590, and one or more network interfaces 1525. In some embodiments, I/O devices 1540 are connected via the I/O interface(s) 1580. Further, via the network interface 1525, the network device 1500 can be communicatively coupled with one or more other devices and components (e.g., via a network, which may include the Internet, local network(s), and the like). Each of the components is communicatively coupled by one or more buses 1530. In some embodiments, one or more antennas 1535 may be coupled to the transceivers 1520 for transmitting and receiving wireless signals.

The processor 1505 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1505 processes information received through the transceiver 1520, I/O interfaces 1590, and the network interfaces 1525. The processor 1505 retrieves and executes programming instructions stored in memory 1510, as well as stores and retrieves application data residing in storage 1515.

The storage 1515 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1515 may store a variety of data for the efficient functioning of the system.

The memory 1510 may include random access memory (RAM) and read-only memory (ROM). The memory 1510 may store processor-executable software code containing instructions that, when executed by the processor 1505, enable the network device 1500 to perform various functions described herein for wireless communication.

As depicted, the memory 1510 includes a (re)association management component 1545, an AID generation component 1550, a time monitoring component 1555, and an EDP scheduling component 1560.

In one embodiment, the (re)association management component 1545 is configured to process incoming (re)association requests from STAs and generate the corresponding (re)association responses. The (re)association management component 1545 may also include logic for inserting the AID List element into outgoing frames.

In one embodiment, the AID generation component 1550 is configured to generate a set of anonymized AIDs for a given STA. In some embodiments, the AID generation component 1550 supports adaptive sizing of the list (e.g., less AIDs included for STA’s size limit). The AID generation component 1550 also tracks historical assignments to prevent reuse.

In one embodiment, the time monitoring component 1555 is configured to track current time with respect to EDP epoch boundaries and transitory periods. The time monitoring component 1555 determines how much time remains in the current epoch when an association request is received (or an association response is sent), and compares the duration to a preconfigured threshold. The evaluation informs conditional decisions such as whether to include the AID list in the (re)association response or defer its delivery to a later action frame. The time monitoring component 1555 also enables retry logic for associations that occur too close to the end of an epoch.

In one embodiment, the EDP scheduling component 1560 is configured to manage the scheduling of action frames that include AID lists. The EDP scheduling component 1560 determines transmission timing based on the epoch clock, transitory period boundaries, and congestion conditions. In configurations that support STA-initiated epoch extension, the component 1560 interprets the specified delay period and adjusts its internal schedule for AID delivery.

Although depicted as a discrete component for conceptual clarity, in some embodiments, the operations of the depicted components (and others not illustrated) may be combined or distributed across any number of components. Further, although depicted as software residing in memory 1510, in some embodiments, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
establishing a wireless communications link between an access point (AP) and a wireless station, wherein establishing the wireless communications link comprises:
receiving an association request frame from the wireless station;
assigning the wireless station to an Enhanced Data Privacy (EDP) group, the EDP group associated with timing information for rotating wireless frame anonymization parameters at epoch transitions;
generating, by the AP, a first list of N association identifiers (AIDs) for the wireless station, each of the N AIDs to be used in a corresponding epoch of N epochs associated with the EDP group; and
transmitting an association response frame to the wireless station, wherein the response frame comprises information indicating the assigned EDP group and the first list of N AIDs for the wireless station; and
maintaining, by the AP, the wireless communications link with the wireless station based at least in part on the timing information for randomized media access control (MAC) address rotation for the EDP group, comprising using each AID in the list of N AIDs during corresponding epochs.

2. The method of claim 1, further comprising
generating, by the AP, a second list of X association identifiers (AIDs) for the wireless station, each of the X AIDs to be used in a corresponding epoch of X epochs associated with the EDP group; and
transmitting, to the wireless station in a protected wireless action frame, information indicating the second list of X AIDs for the wireless station.

3. The method of claim 2, wherein X is greater than N.

4. The method of claim 1, further comprising
providing, by the AP, a first communication indicating that the AP supports a randomized Media Access Control (MAC) address rotation management protocol.

5. The method of claim 1, wherein the association request frame comprises a protected association request frame that comprises rotation pace preference information for randomized Media Access Control (MAC) address rotation management, and the rotation pace preference information indicates a preferred rotation pace.

6. The method of claim 1, wherein the AIDs in the list of N AIDs are assigned from a preexisting range of AIDs.

7. The method of claim 1, wherein each AID in the list of N AIDs is to be used in a corresponding epoch of a set of future, consecutive epochs.

8. The method of claim 1, wherein each AID in the list of N AIDs is unique to the wireless station during an epoch corresponding to the AID.

9. The method of claim 2, further comprising:
before an end of the X epochs:
generating, by the AP, a third list of association identifiers (AIDs) for the wireless station, each of the AIDs to be used in a corresponding epoch associated with the EDP group; and
transmitting, to the wireless station in a second protected wireless frame, information indicating the third list of AIDs for the wireless station.

10. The method of claim 1, further comprising
receiving, by the AP, a wireless frame indicating a request for a new list of AIDs.

11. A wireless access point (AP), comprising:
at least one memory element for storing data; and
at least one processor for executing instructions associated with the data, wherein executing the instructions causes the AP to perform operations, comprising:
establishing a wireless communications link between the AP and a wireless station, wherein establishing the wireless communications link comprises:
receiving an association request frame from the wireless station;
assigning the wireless station to an Enhanced Data Privacy (EDP) group, the EDP group associated with timing information for rotating wireless frame anonymization parameters at epoch transitions;
generating a first list of N association identifiers (AIDs) for the wireless station, each of the N AIDs to be used in a corresponding epoch of N epochs associated with the EDP group; and
transmitting an association response frame to the wireless station, wherein the response frame comprises information indicating the assigned EDP group and the first list of N AIDs for the wireless station; and
maintaining the wireless communications link with the wireless station based at least in part on the timing information for randomized media access control (MAC) address rotation for the EDP group, comprising using each AID in the list of N AIDs during corresponding epochs.

12. The wireless access point of claim 11, the operations further comprising:
generating, by the AP, a second list of X association identifiers (AIDs) for the wireless station, each of the X AIDs to be used in a corresponding epoch of X epochs associated with the EDP group; and
transmitting, to the wireless station in a protected wireless action frame, information indicating the second list of X AIDs for the wireless station.

13. The wireless access point of claim 12, wherein X is greater than N.

14. The wireless access point of claim 11, the operations further comprising:
providing a first communication indicating that the AP supports a randomized Media Access Control (MAC) address rotation management protocol.

15. The wireless access point of claim 11, wherein the association request frame comprises a protected association request frame that comprises rotation pace preference information for randomized Media Access Control (MAC) address rotation management, wherein the rotation pace preference information indicates a preferred rotation pace.

16. The wireless access point of claim 11, wherein the AIDs in the list of N AIDs are assigned from a preexisting range of AIDs.

17. The wireless access point of claim 11, wherein each AID in the list of N AIDs is to be used in a corresponding epoch of a set of future, consecutive epochs.

18. The wireless access point of claim 11, wherein each AID in the list of N AIDs is unique to the wireless station during an epoch corresponding to the AID.

19. The wireless access point of claim 12, the operations further comprising:
before an end of the X epochs:
generating, by the AP, a third list of association identifiers (AIDs) for the wireless station, each of the AIDs to be used in a corresponding epoch associated with the EDP group; and
transmitting, to the wireless station in a second protected wireless frame, information indicating the third list of AIDs for the wireless station.

20. The wireless access point of claim 11, the operations further comprising:
receiving, from the wireless station, a wireless frame indicating a request for a new list of AIDs.

21. A non-transitory computer readable storage medium comprising instructions that when executed configure one or more processors of a wireless access point (AP) to perform operations comprising:
establishing a wireless communications link between the AP and a wireless station, wherein establishing the wireless communications link comprises:
receiving an association request frame from the wireless station;
assigning the wireless station to an Enhanced Data Privacy (EDP) group, the EDP group associated with timing information for rotating wireless frame anonymization parameters at epoch transitions;
generating a first list of N association identifiers (AIDs) for the wireless station, each of the N AIDs to be used in a corresponding epoch of N epochs associated with the EDP group; and
transmitting an association response frame to the wireless station, wherein the response frame comprises information indicating the assigned EDP group and the first list of N AIDs for the wireless station; and
maintaining the wireless communications link with the wireless station based at least in part on the timing information for randomized media access control (MAC) address rotation for the EDP group, comprising using each AID in the list of N AIDs during corresponding epochs.

22. The non-transitory computer readable storage medium of claim 21, the operations further comprising:
generating, by the AP, a second list of X association identifiers (AIDs) for the wireless station, each of the X AIDs to be used in a corresponding epoch of X epochs associated with the EDP group; and
transmitting, to the wireless station in a protected wireless action frame, information indicating the second list of X AIDs for the wireless station.
